(19) United States
(12) Patent Application Publication
(10) Pub. No.: US 2014/0333267 A1
(43) Pub. Date: Nov. 13, 2014

(54) HEATED ACCELERATED BATTERY CHARGING

(71) Applicant: Fairchild Semiconductor Corporation, San Jose, CA (US)

(72) Inventor: Philip J. Crawley, Oceanside, CA (US)

(73) Assignee: Fairchild Semiconductor Corporation, San Jose, CA (US)

(21) Appl. No.: 14/275,510

(22) Filed: May 12, 2014

Related U.S. Application Data
(60) Provisional application No. 61/821,771, filed on May 10, 2013.

(51) Int. Cl. H01M 10/63; H01M 10/6571; H02J 7/00

(52) U.S. Cl. CPC H01M 10/502; H02J 7/0052; H01M 10/5083
USPC 320/150; 429/62; 429/50

(57) ABSTRACT

This document discusses, among other things, a temperature measurement component configured to receive temperature information from a battery, a heater configured to provide heat to the battery, and a controller configured to enable and disable the heater using information from the temperature measurement component to optimize charge efficiency and capacity of the battery.

### CLAIM OF PRIORITY

The present application claims the benefit of priority to U.S. Provisional Patent Application Ser. No. 61/821,771, filed May 10, 2013, which is incorporated herein by reference in its entirety.

### BACKGROUND

Battery performance generally varies with temperature. Similarly, battery charge characteristics also vary with temperature. Ambient battery temperatures can be 0° C. or lower, whereas efficient battery charging temperatures can approach temperatures of 25° C. to 35° C. Various technologies exist with respect to battery charging and temperature. For example, Wang et al. U.S. Pat. No. 8,334,675 heats a battery at low temperature by pulse charging and discharging up to a desired temperature and then charging using a normal charging mode. However, said pulse charging and discharging to heat the battery wastes power, requires time, and unnecessarily cycles the battery. In contrast, Miyano US Patent Application No. 20120305662 blows warm, dehumidified wind toward the battery to warm the battery without dew condensation. However, such a system requires a dehumidifier to reduce dew condensation on the battery pack from the warm wind.

### OVERVIEW

This document discusses, among other things, a temperature measurement component configured to determine a temperature of a battery (e.g., a mobile phone battery), a heater configured to provide heat to the battery, and a controller configured to enable and disable the heater using the battery temperature to optimize charge efficiency and capacity of the battery.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1 and 2 illustrate generally example systems including a battery, a heater, a battery charger, and a temperature measurement component.

FIG. 3 illustrates generally an example control method for the systems of FIGS. 1 and 2.

FIGS. 4 and 5 illustrate generally example thin film heaters configured to apply heat to an anode of a battery.

### DETAILED DESCRIPTION

The present inventors have recognized, among other things, a heater and a temperature measurement component that work in unison to optimize charge efficiency (e.g., enable increased charge rates) and capacity of a battery with respect to battery temperature. The temperature measurement component can measure the battery temperature, for example, directly (e.g., at the battery surface), using a direct temperature measurement component (e.g., a thermistor, etc.), or indirectly using one or more measurements of the battery, such as battery voltage or current measurements, and one or more known temperature characteristics of the battery, such as the state-of-charge (SOC) or the open-circuit voltage (OCV). Charging power to the battery can then be optimized using the battery temperature.

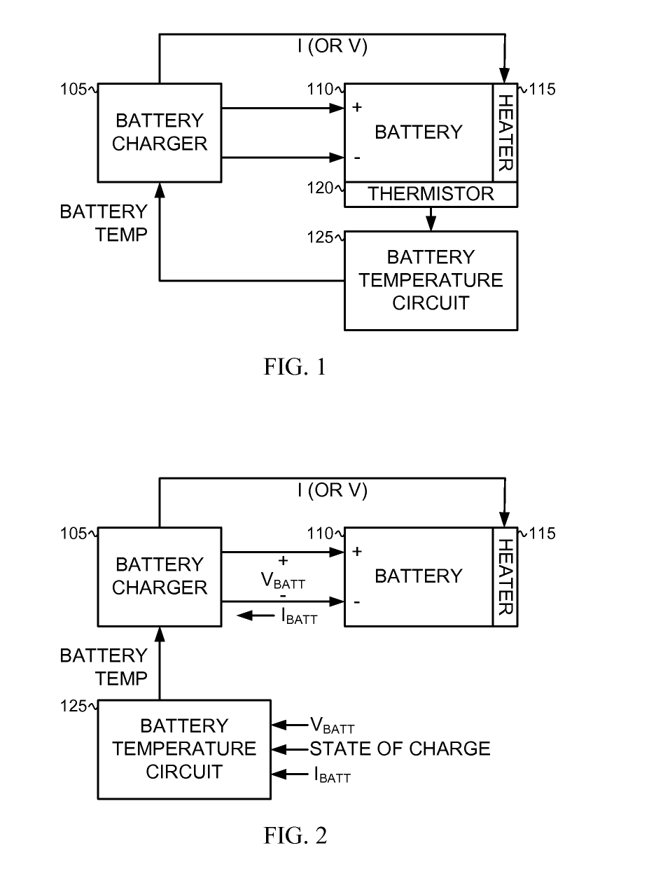

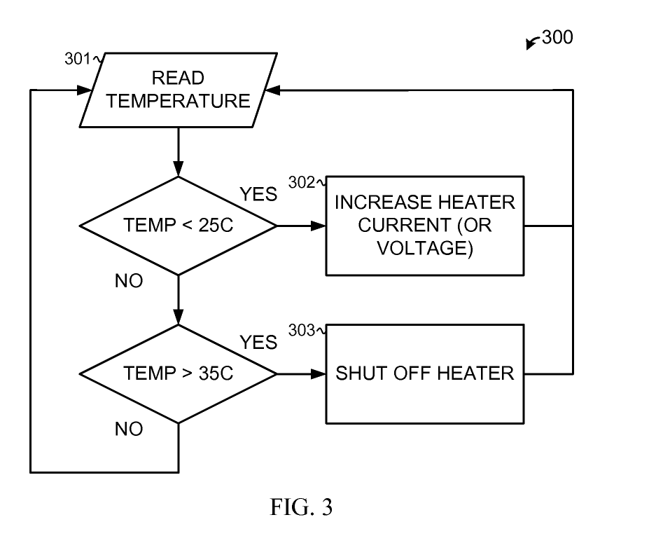

FIGS. 1 and 2 illustrate generally example systems including a battery 110, a heater 115, a battery charger 105, and a temperature measurement component. The battery charger 105 can include a battery fuel gauge (BFG). In an example, the battery charger 105 and the temperature measurement component can enable increased charge rates in the battery 110, optimizing battery charge rate with respect to battery temperature.

In the example of FIG. 1, the temperature measurement component includes a direct temperature measurement component, e.g., a thermistor 120, and a battery temperature circuit 125, in certain examples, including a battery temperature algorithm configured to determine a battery temperature using information from the temperature measurement component. In example, the battery temperature circuit can include digital or analog components coupled to, included within, or separate from one or more of the battery charger 105, the battery 110, the heater 115, the direct temperature measurement component, or one or more other components. In an example, the temperature measurement component can be in physical contact with the surface of the battery 110. The temperature measurement component can provide information to the battery temperature circuit 125 (e.g., a voltage, a current, a resistance, etc.), and the battery temperature circuit 125 can be configured to provide battery temperature information to the battery charger 105 (e.g., analog or digital information indicative of a temperature, or information about whether or not the temperature is above or below one or more thresholds, etc.). In an example, the battery charger 105 can apply power to the battery 110 or the heater 115 based on the battery temperature information and a thermal model of the battery 110.

In an example, the heater 115 can be configured to ensure that the battery anode is above a minimum temperature to ensure an efficient charge rate of the battery. In certain examples, the temperature measurement component (e.g., the thermistor 120) can be physically located proximate the battery anode to facilitate such measurement, or the temperature measurement component can include a plurality of components, one being located proximate the battery anode or one or more other specific locations, such as the battery cathode, a portion of the battery 110 away from (e.g., farthest away from) other heat-producing circuit components (e.g., a baseband processor, transmission circuitry, the battery charger 105, etc.), etc.

The heater 115 can receive power from the battery charger 105. In certain examples, the heater 115 can include a thin film electrical heater configured to surround or be coupled to the outside of the battery 110. In an example, the heater 115 can provide a specified temperature, or the heater 115 can provide a range of temperature depending on the power received from the battery charger 105. In an example, the heater 115 can be configured to heat the battery 110 only during battery charging, e.g., beginning at the same time the battery charging begins. In another example, the heater 115 can be configured to heat the battery 115 before battery charging, such to ensure that the battery temperature is above the minimum temperature at the beginning of battery charging, e.g., by calculating an estimated battery charging time using one or more characteristics of the battery 110, the battery temperature, or an estimated heating time for the battery 110 by the heater 115. However, the present inventors have recognized that minimizing the heating time of the battery 110 can minimize the impact of heating on solid electrolyte interphase (SEI) growth, a major driver of battery capacity loss. The present inventors have recognized that, in certain examples, a 10° C. temperature change can double or half the rate of chemical reactions in a battery 110 leading to, for example, SEI growth and reduced battery capacity. Thus, heating the battery 110 only during charging, or in another example, only during and leading up to charging, or holding the battery temperature within a specified temperature range, can balance charging efficiency and SEI growth.

In the example of FIG. 2, the battery temperature circuit 125 can indirectly measure the battery temperature using one or more measurements of the battery, such as battery voltage (V_{batt}), battery current (I_{batt}), or one or more other measurements, in certain examples, in combination with one or more known temperature characteristics of the battery 110, such as a known temperature profile, coefficient, state-of-charge (SOC), open-circuit voltage (OCV) of the battery 110. In an example, the SOC or the OCV of the battery 110 can be managed by a battery fuel gauge.

The resistance of a battery can change as a battery ages. In certain examples, battery fuel gauges can track the age or use of the battery. Further, battery resistance can be known at different temperatures and ages.

FIG. 3 illustrates generally an example control method 300 for the systems of FIGS. 1 and 2. In an example, the illustrated control method 300 can be enabled once the battery charger begins charging the battery. In another example, the control method 300 can be enabled just prior to charging, for example, using an estimated battery warming time. The object of the specific example of FIG. 3 is to ensure that the battery temperature is maintained in a 10° C. range, in this example, between 25° C. and 35° C. In other examples, other ranges or temperatures can be used depending on various factors, such as different battery characteristics or conditions. Further, more complex, detailed control can be provided if desired.

At 301, the battery temperature can be read or estimated using one or more battery parameters. At 302, if the temperature is less than 25° C., heater power (e.g., current or voltage) can be enabled or increased. At 303, if the temperature is greater than 35° C., heater power can be disabled or reduced.

In certain examples, if the battery temperature is below the desired range, charging of the battery can start conservatively and then ramp as the battery temperature approaches the desired range.

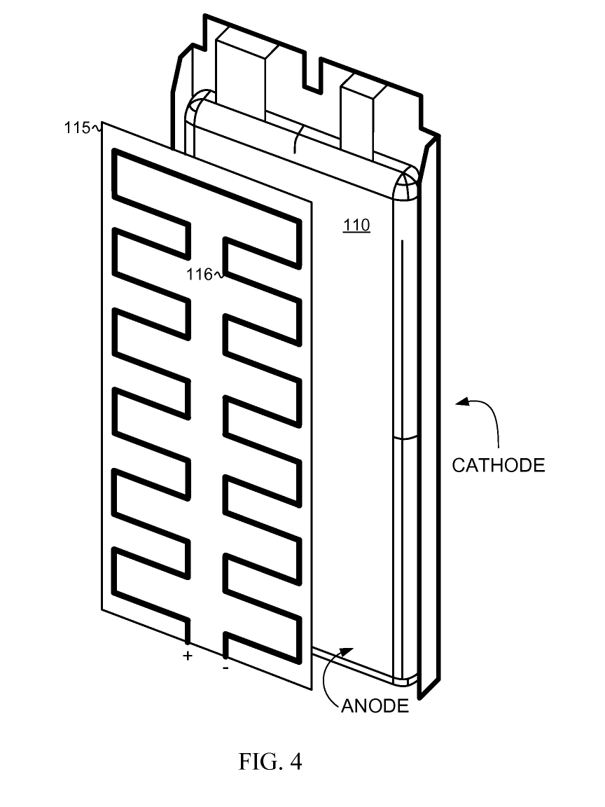

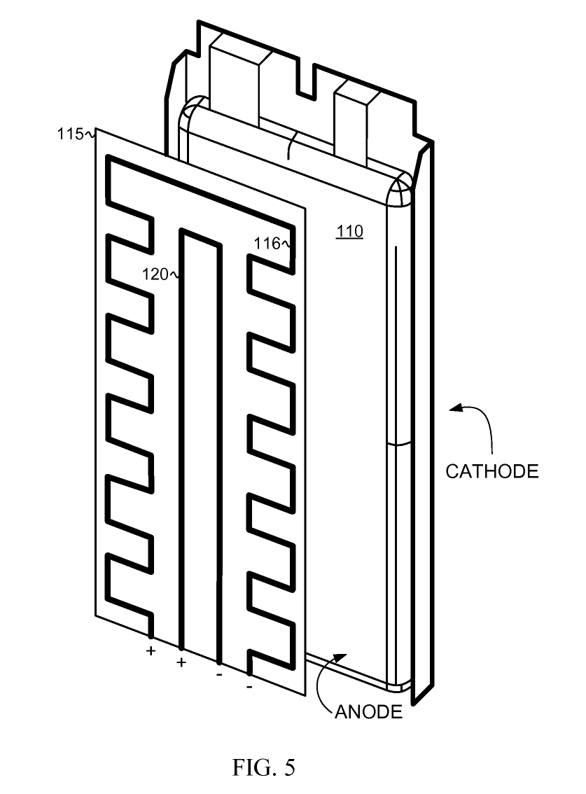

FIGS. 4 and 5 illustrate generally example thin film heaters 115 configured to apply heat to an anode of a battery 110. In the example of FIG. 4, a thin film resistor 116 is applied to an anode of a battery 110 and a separate temperature measurement component is configured to receive temperature information from the battery 110. In the example of FIG. 5, a separate film resistor (e.g., a thermistor 120) is integrated with the film heater 115 to measure battery temperature. In this example, the thermistor 120 is located central to the film heater 115. In other examples, other shapes or configurations can be used.

Power consumption of the thin film heaters illustrated in FIGS. 4 and 5 during charging can be relatively small (e.g., ˜0.4 A or less) with a relatively small thickness with respect to the overall battery 110 (e.g., 0.1 mm or less), yet can provide substantial charging and capacity benefits to the battery 110.

Anode and Cathode Reactions in a Lithium (Li) Battery

As Li ions are removed from a cathode of a battery during charging, an electron is removed. A similar action occurs at an anode of the battery. Mass diffusion carries Li to anode where intercalation occurs. This mass transfer is limited, however, by chemical reaction rate. Diffusion is a result of the concentration differences at the cathode to the anode. During fast charging, Li+ concentrations reach a level where an Li metal layer forms, resisting future diffusion events and decreasing the maximum level of charge storage.

Chemical reactions occur more quickly with higher temperatures, driven by Arrhenius depencence, namely D=Aê(−E/(k_{B}T)), where D is the rate of diffusion, A is a constant based on the materials in question, E is the activation energy, k_{B} is Boltzmann's constant, and T is temperature. Typically, a 10° C. temperature change can double or half the rate of chemical reactions.

Additional Notes and Examples

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An apparatus comprising:
a temperature measurement component configured to receive temperature information from a battery;
a heater configured to provide heat to the battery; and
a controller configured to enable and disable the heater using information from the temperature measurement component.

2. The apparatus of claim 1, wherein the temperature measurement component is coupled to an exterior housing of the battery and is configured to detect temperature information on the exterior housing of the battery.

3. The apparatus of claim 2, wherein the temperature measurement component is coupled to an anode of the battery and is configured to detect temperature information at the anode of the battery.

4. The apparatus of claim 1, wherein the temperature measurement component includes a thermistor.

5. The apparatus of claim 1, wherein the controller is configured to receive temperature information from the temperature measurement component and to estimate battery temperature using the received temperature information and a characteristic of the battery.

6. The apparatus of claim 1, wherein the heater is coupled to an exterior housing of the battery.

7. The apparatus of claim 6, wherein the heater is coupled to an anode of the battery.

8. The apparatus of claim 6, wherein the heater includes a thin film heater, and
wherein the temperature measurement component is integrated with the heater.

9. The apparatus of claim 1, including:
a battery charger configured to charge the battery and to provide power to the heater,
wherein the controller is configured to control the heater to maintain a specified temperature range in the battery during charging of the battery.

10. The apparatus of claim 9, wherein the specified temperature range includes between 25° C. and 35° C. to maintain a specified battery charging efficiency while minimizing solid electrolyte interphase (SEI) growth.

11. A method comprising:
receiving temperature information from a battery using a temperature measurement component;
providing heat to the battery using a heater; and
enabling and disabling the heater using information from the temperature measurement component.

12. The method of claim 11, wherein receiving temperature information from the battery includes receiving temperature information from an exterior housing of the battery using a temperature measurement component coupled to the exterior housing of the battery.

13. The method of claim 12, wherein receiving temperature information from the battery includes receiving temperature information from an anode of the battery using a temperature measurement component coupled to the anode of the battery.

14. The method of claim 11, including:
estimating battery temperature using the received temperature information and a characteristic of the battery; and
enabling and disabling the heater using the estimated battery temperature.

15. The method of claim 11, wherein the heater is coupled to an exterior housing of the battery.

16. The method of claim 15, wherein the heater includes a thin film heater, and
wherein the temperature measurement component is integrated with the heater.

17. The method of claim 11, including:
charging the battery and providing power to the heater using a battery charger; and
controlling the heater to maintain a specified temperature range in the battery during charging of the battery.

18. The method of claim 17, wherein the specified temperature range includes between 25° C. and 35° C., and
wherein controlling the heater includes to maintain a specified battery charging efficiency while minimizing solid electrolyte interphase (SEI) growth.

19. The method of claim 17, including enabling the heater only during charging of the battery.

20. A system comprising:
a mobile device including a battery;
a temperature measurement component coupled to an exterior housing of the battery, the temperature measurement component configured to receive temperature information from the battery;
a heater coupled to the exterior housing of the battery, the heater configured to provide heat to the battery;
a controller configured to enable and disable the heater using information from the temperature measurement component;
a battery charger configured to charge the battery and to provide power to the heater,
wherein the controller is configured to control the heater during charging of the battery to maintain a specified temperature range in the battery during charging,
wherein the specified temperature range includes between 25° C. and 35° C. to maintain a specified battery charging efficiency while minimizing solid electrolyte interphase (SEI) growth.
